(19) United States
(12) Patent Application Publication
(10) Pub. No.: US 2012/0247519 A1
(43) Pub. Date: Oct. 4, 2012

(54) PNEUMATIC DEVICE FOR CLEARING DRAIN OBSTRUCTIONS IN A PLUMBING FIXTURE

(75) Inventors: MEHMET DONDURUR, DHAHRAN (SA); AHMET Z. SAHIN, DHAHRAN (SA)

(73) Assignee: KING FAHD UNIVERSITY OF PETROLEUM AND MINERALS, DHAHRAN (SA)

(21) Appl. No.: 13/074,953

(22) Filed: Mar. 29, 2011

(51) Int. Cl. B08B 3/00

(52) U.S. Cl. 134/169 R

(57) ABSTRACT

The pneumatic device for clearing drain obstructions in a plumbing fixture includes an electropneumatic pump. In some embodiments, the pump is located at the top of the handle of a plunger having a resilient force cup, pneumatic pressure being transmitted through a handle passage to the cup. In another embodiment, the device includes a distensible drain seal extending from the cup when pressure is applied therein, and a pneumatically actuated piston in the handle. The piston drives a semi-flexible wire outward through the cup and distensible seal to produce a mechanical force for clearing an obstruction. In another embodiment, the device includes a pneumatic pump permanently installed with a toilet, the pump selectively providing pressure within the bowl to dislodge obstructions in the drain. Seals are provided for the seat and lid, and a retaining strap is used to hold the seat and lid in place during pump operation.

### BACKGROUND OF THE INVENTION

1. Field of the Invention

The present invention relates to plumbing system repairs, and particularly to various embodiments of an electrically powered pneumatic device for clearing obstructions in a plumbing fixture, such as a sink trap, toilet trap, or the like.

2. Description of the Related Art

Obstructions are known to occur from time to time in waste drains for sinks, toilets, and the like in various business, residence, and other structures incorporating such facilities. This may be due to any of a number of causes, e.g., foreign objects dropped in the toilet or other drain system, excessive volume of waste or paper deposited in a toilet, grease and pieces of food or other matter washed into a kitchen sink drain, hair and other organic matter trapped in bathroom drains, etc. When such stoppages or obstructions occur, the associated plumbing fixture is unusable and subject to wastewater backup and/or overflow. Such a situation is at least a minor emergency, requiring clearing as soon as possible.

Accordingly, a number of different devices and methods have been developed in the past for clearing blocked drain systems. Perhaps the earliest solution to such stoppages was the use of hot water in a sink where grease was suspected of causing the blockage. While hot water will dissolve such grease blockages, getting the hot water to the location in the drain trap where it is needed may be a major problem, particularly if the sink has been filled with water beforehand. For hot water to be effective, all water must be siphoned from the sink at least down into the drain, and this may be a time consuming and messy chore. Much the same holds true for chemical treatments, i.e., lye and the like. Such treatments will only be effective if they can actually reach the location of the stoppage in the drain. The addition of such chemicals into a sink that is filled with water dilutes the chemical to the point that it is not likely to be effective.

The conventional manually operated plunger has been known for a considerable period of time, since shortly after the development of indoor plumbing facilities. While conventional plungers are pneumatic devices, they are strictly manually powered and have no means for accommodating additional power from electrically powered pumps or the like. Moreover, they operate best if pushed or “plunged” in a reciprocating motion to create rapidly changing pulses of hydraulic pressure on the obstruction in the drain. If the clogged fixture is full, or nearly full, of water, the agitation of the water will almost certainly cause it to splash out of the fixture, thereby creating another mess.

Yet another solution is the use of an auger or “snake” to clear the obstruction. Such devices are not normally found in the average household, and a professional having such a tool must be called in to apply it to the blocked drain passage. Such mechanical devices are no doubt quite effective, but they are primarily intended for use in clearing blockages farther down the drain system, e.g., where roots have entered cracked pipes beneath the surface at some distance from the structure. Their use in clearing an obstruction in a sink or toilet drain trap is generally unwarranted due to the cost of hiring a professional with such equipment to take care of the problem.

Thus, a pneumatic device for clearing drain obstructions in a plumbing fixture solving the aforementioned problems is desired.

### SUMMARY OF THE INVENTION

The pneumatic device for clearing drain obstructions in a plumbing fixture includes several different embodiments, each having an electrically powered pneumatic pump providing pressure to clear a drain trap. One embodiment has a configuration much like a conventional manually operated plunger, but includes an electrically powered pneumatic pump near the upper end of the handle and an air passage extending through the handle and into the resilient force cup or plunger cup of the plunger. The plunger is placed over the drain outlet in the conventional manner to form a seal, and the electropneumatic pump is actuated. This increases the pressure within the force cup of the plunger and into the drain, thereby pushing the obstruction through the drain.

Another embodiment includes an inflatable or distensible component extending from the mouth of the plunger cup, and an external line extending from the electropneumatic pump to the cup or its distensible component. The handle shaft contains a piston that is actuated by the electropneumatic pump, the piston driving a semi-flexible wire or the like downward and outward through the cup and the distensible component to dislodge the obstruction mechanically, in addition to the pressure produced by the distensible component as it is inflated to seal the drain.

Still another embodiment comprises an electropneumatic pump installed as a permanent component with a toilet. The pump may be selectively activated to apply pressure into the toilet bowl to force an obstruction through the drain trap. Seals are provided between the rim of the bowl and the seat, and between the seat and lid. A retaining strap is used to hold the seat and lid in place in order to seal the pressure within the bowl.

These and other features of the present invention will become readily apparent upon further review of the following specification and drawings.

### BRIEF DESCRIPTION OF THE DRAWINGS

FIG. 1 is an environmental front elevation view in section of a first embodiment of a pneumatic device for clearing drain obstructions in a plumbing fixture according to the present invention, showing its operation in clearing an obstruction in a sink trap.

FIG. 2 is an environmental front elevation view in section of an alternative embodiment of a pneumatic device for clearing drain obstructions in a plumbing fixture according to the present invention, illustrating its operation in clearing an obstruction in a toilet trap.

FIG. 3 is an environmental front elevation view in section of another alternative embodiment of a pneumatic device for clearing drain obstructions in a plumbing fixture according to the present invention, illustrating its operation in clearing an obstruction in a toilet trap.

FIG. 4 is an environmental side elevation view in section of another alternative embodiment of a pneumatic device for clearing drain obstructions in a plumbing fixture according to the present invention, illustrating its installation and use in clearing an obstruction in a toilet trap.

Similar reference characters denote corresponding features consistently throughout the attached drawings.

### DETAILED DESCRIPTION OF THE PREFERRED EMBODIMENTS

The pneumatic device for clearing drain obstructions in a plumbing fixture comprises several embodiments, each of which includes means for forming a pneumatically sealed chamber with the fixture and an electropneumatic pump for supplying pneumatic pressure to the sealed chamber. The person using any of the embodiments of the device need not exert any physical force to the device, other than sufficient force to hold the force cup or plunger cup securely against the fixture around the drain in order to provide a good pneumatic seal. Manually pumping the device upward and downward to produce oscillations in the pressure to the drain is not required when using any of the embodiments of the pneumatic device.

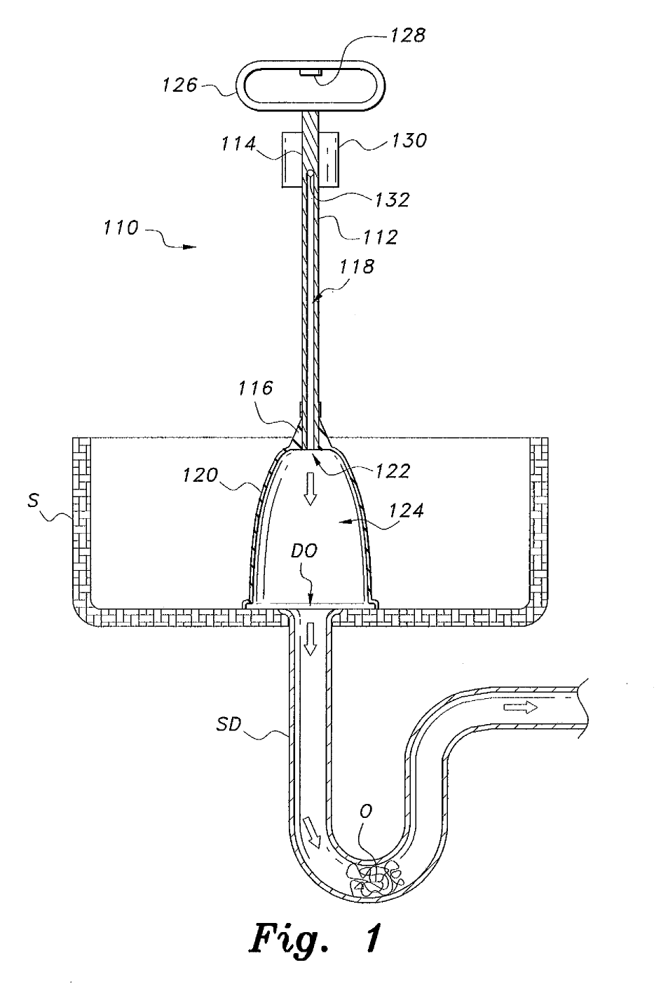

FIG. 1 provides an environmental front elevation view in section of a first embodiment of the pneumatic device as it would be used to clear an obstruction O in the sink trap or sink drain SD of a sink S (e.g., kitchen sink, bathroom sink, etc.). The pneumatic device 110 includes a rigid, elongate hollow shaft 112 having a handle end 114 and an opposite outlet or force cup attachment end 116. The hollow interior of the shaft 112 comprises a pneumatic passage or line 118 extending from the handle end 114 to the outlet end 116 thereof. A resilient plunger force cup 120 is affixed to the outlet or force cup end 116 of the shaft 112. The force cup 120 has a pneumatic line or passage 122 disposed therethrough and concentric with the pneumatic line or passage 118 of the shaft 112. It will be seen that when the force cup 120 is applied to the drain opening DO of the sink S, the interior volume of the force cup 120 and the interior volume of the sink drain SD define a pneumatically sealed chamber 124 between the force cup 120 and the obstruction O.

The opposite handle end 114 of the shaft 112 includes a handgrip 126 extending therefrom. The handgrip 126 has an electric pump control switch 128 thereon. A conventional electropneumatic pump 130 is also attached to the handle end 114 of the shaft 112. The electric switch 128 communicates electrically with the pump 130 to provide selective control of the pump 130. The pump 130 has an outlet 132 that communicates pneumatically with the pneumatic passage or line 118 of the shaft 112. The pump 130 may be powered by one or more conventional electrical storage cells or batteries, or may be powered by a conventional remote electrical power source, e.g., electrical power grid, generator, etc. Such electrical power sources are well known and need not be described in further detail herein. It is anticipated that the pump 130 may develop significant pressure, and accordingly the pump may include a conventional pressure regulator (not shown). Such regulators are known in the art of pneumatic pumps. One example of such a regulator is a diaphragm-actuated electric switch that automatically cycles the pump 130 off and on when a predetermined pressure is reached. Another example might be a pressure relief valve that opens to relieve excessive pneumatic pressure upon reaching a predetermined pressure. Again, such pressure regulators are known in the art and need not be described in further detail herein. The advantage to such pressure regulation is that the user of the pneumatic device 110 will not be overpowered by excessive pneumatic pressure being developed within the sealed chamber 124 as he or she holds down the handgrip 126 of the device.

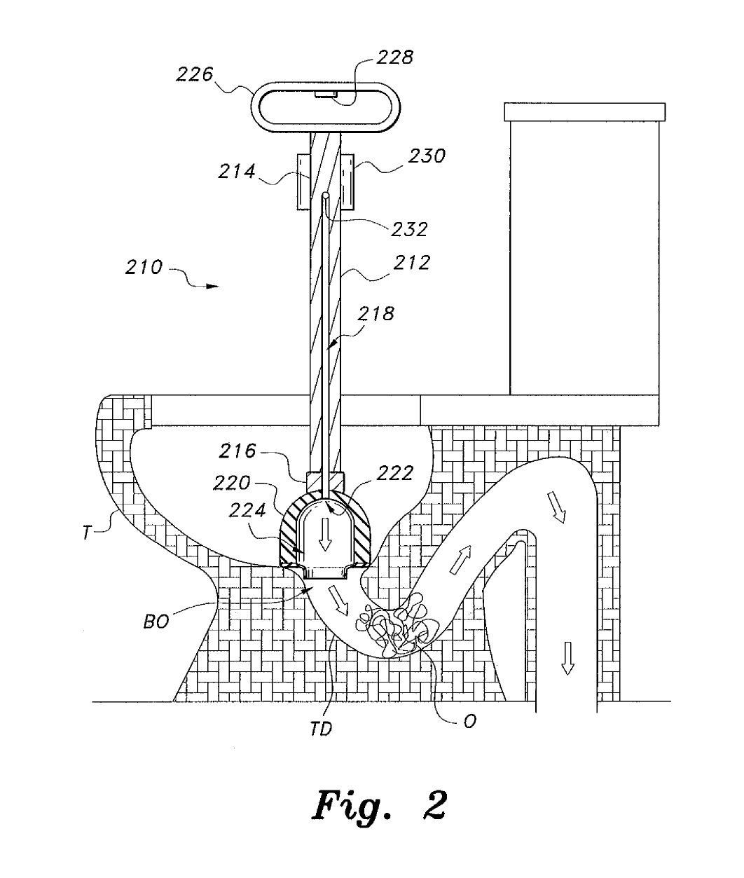

FIG. 2 of the drawings provides an environmental front elevation view in section of an alternative embodiment of the pneumatic device, shown being used to clear an obstruction in a toilet drain TD of a toilet T. (The conventional toilet seat and lid are not shown in FIG. 2 for clarity in the drawing.) It will be seen that either pneumatic device 110 or 210 may be used interchangeably to clear an obstruction in either a sink drain SD, as shown in FIG. 1, or a toilet drain TD, as shown in FIG. 2. The only differences between the device 110 of FIG. 1 and the device 210 of FIG. 2 are in certain relatively minor changes to the shapes or configurations of various components, equivalent components having corresponding reference numerals differing only in their first digit. The pneumatic device 210 of FIG. 2 includes a rigid, elongate hollow shaft 212 having a handle end 214 and an opposite outlet or force cup attachment end 216. The hollow interior of the shaft 212 comprises a pneumatic line or passage 218 extending from the handle end 214 to the outlet end 216. While the shaft 212 of the pneumatic device 210 is somewhat larger in diameter than the shaft 112 of the device 110, the two components are equivalent and may be interchanged.

A resilient plunger force cup 220 is affixed to the outlet or force cup end 216 of the shaft 212. The force cup 220 has a pneumatic line or passage 222 disposed therethrough concentric with the pneumatic passage or line 218 of the shaft 212. While the force cup 220 of the pneumatic device 210 has a somewhat different configuration than the force cup 120 of the device 110 of FIG. 1, they are equivalent components and may be interchanged. It will be seen that when the force cup 220 is applied to the bowl outlet BO of the toilet T, the interior volume of the force cup 220 and the interior volume of the toilet drain TD define a pneumatically sealed chamber 224 between the force cup 220 and the obstruction O.

The opposite handle end 214 of the shaft 212 includes a handgrip 226 extending therefrom. The handgrip 226 has an electric pump control switch 228 thereon. A conventional electropneumatic pump 230 is also attached to the handle end 214 of the shaft 212. The electric switch 228 communicates electrically with the pump 230 to provide selective control of the pump 230. The pump 230 has an outlet 232 that communicates pneumatically with the pneumatic passage or line 218 of the shaft 212. The pump 230 may be powered by one or more conventional electrical storage cells or batteries, or may be powered by a conventional remote electrical power source, e.g., electrical power grid, generator, etc., as in the case of the embodiment 110 of FIG. 1. The pump 230 may also include a conventional pressure regulator (not shown), as in the embodiment 110 of FIG. 1.

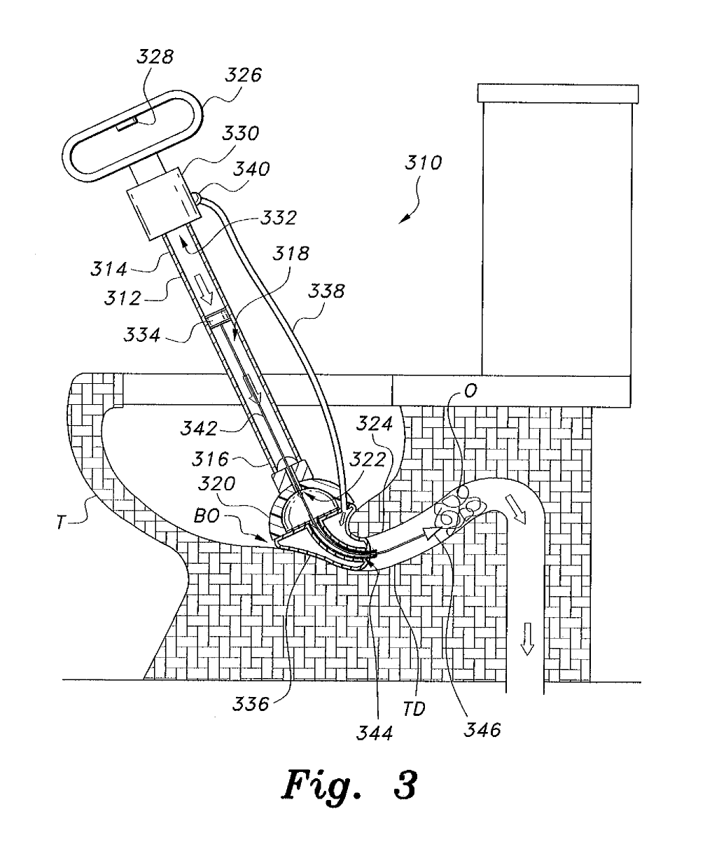

FIG. 3 provides a front elevation view in section of another alternative embodiment, designated by the reference numeral 310. Again, equivalent components of the various embodiments have corresponding reference numerals differing only in the first digit. The pneumatic device 310 of FIG. 3 includes a rigid, elongate hollow shaft 312 having a handle end 314 and an opposite outlet or force cup attachment end 316. The hollow interior of the shaft 312 comprises a pneumatic line or passage 318 extending from the handle end 314 to the outlet end 316 thereof. The pneumatic passage 318 of the shaft 312 is somewhat larger in diameter than the pneumatic passages or lines of the embodiments of FIGS. 1 and 2, as the passage 318 contains a piston 334 that is pneumatically actuated by the electropneumatic pump 330 at the handle end 314 of the shaft 312. The function of this piston 334 is discussed further below.

A resilient plunger force cup 320 is affixed to the outlet or force cup end 316 of the shaft 312. The force cup 320 has a pneumatic line or passage 322 disposed therethrough concentric with the pneumatic passage or line 318 of the shaft 312. The force cup 320 of the pneumatic device 310 may have a similar configuration to the force cup 220 of the device 210 of FIG. 2, but includes a distensible drain seal 336 that is selectively extendible from the mouth of the cup 320. The distensible seal 336 has a generally toroidal configuration topologically, the seal 336 having an interior volume separated from the pneumatic passage 318 within the shaft 312. A second pneumatic line or passage 338 extends from the electropneumatic pump 330 to the force cup 320, and provides pneumatic pressure for the inflation of the drain seal 336 when the pump 330 is actuated. The second pneumatic line 338 is shown disposed externally to the shaft 312, but it will be seen that this second line 338 may be formed parallel to and immediately adjacent to the internal passage 318 of the shaft 312 as an integral component of the shaft 312.

The opposite handle end 314 of the shaft 312 includes a handgrip 326 extending therefrom. The handgrip 326 has an electric pump control switch 328 thereon. A conventional electropneumatic pump 330 is also attached to the handle end 314 of the shaft 312. The electric switch 328 communicates electrically with the pump 330 to provide selective control of the pump 330. The pump 330 may be powered by one or more conventional electrical storage cells or batteries, or may be powered by a conventional remote electrical power source, e.g., electrical power grid, generator, etc., as in the case of the pneumatic devices 110 of FIGS. 1 and 210 of FIG. 2. The pump 330 may also include a conventional pressure regulator (not shown), as in the devices 110 of FIGS. 1 and 210 of FIG. 2.

The pump 330 has an outlet 332 that communicates pneumatically with the internal pneumatic passage or line 318 of the shaft 312. The pump 330 has a second outlet 340 that communicates pneumatically with the second pneumatic passage or line 338. The pneumatic device 310 is used by placing the mouth of the force cup 320 over the bowl outlet BO in the toilet T. Sufficient force is applied to the handgrip 326 to form a seal between the edge of the force cup 320 and the area surrounding the bowl outlet BO, thereby forming a pneumatically sealed chamber 324 in the toilet drain TD between the force cup 320 and the obstruction O farther down in the toilet drain TD, generally as shown in FIG. 3.

Actuation of the electropneumatic pump 330 of the embodiment 310 shown in FIG. 3 simultaneously accomplishes two objectives. One part of the operation is the delivery of pressurized air from the pump 330 to the distensible seal 336 by means of the second pneumatic line or passage 338. This causes the seal 336 to inflate at the mouth of the force cup 320 so that the seal expands and extends into the bowl opening BO of the toilet T to provide a good seal thereto. Also, the pump 330 is delivering pressurized air to the pneumatic passage 318 of the shaft 312. This forces the piston 334 toward the force cup end 316 of the shaft 312. It will be noted that a fairly stiff, semi-flexible wire 342 or the like extends from the piston 334 and down the shaft 312 to pass through the pneumatic passage 322 of the force cup 320 and outward from the device 310 through a passage 344 through the center of the distensible seal 336. The wire 342 terminates in a distal obstruction dislodging end 346, which may have any suitable shape, e.g., pointed, as shown, or blunt, etc. As the piston 334 is driven toward the force cup end 316 of the shaft 312, the wire 342 is pushed outwardly through the passage 344 of the distensible seal 336, and the obstruction dislodging end 346 of the wire 342 contacts the obstruction O. This combination of pneumatic pressure forcing the obstruction O through the toilet drain TD, and the mechanical force applied by the wire 342 to the obstruction O, results in an efficient means of removing an obstruction O from a toilet trap or drain TD.

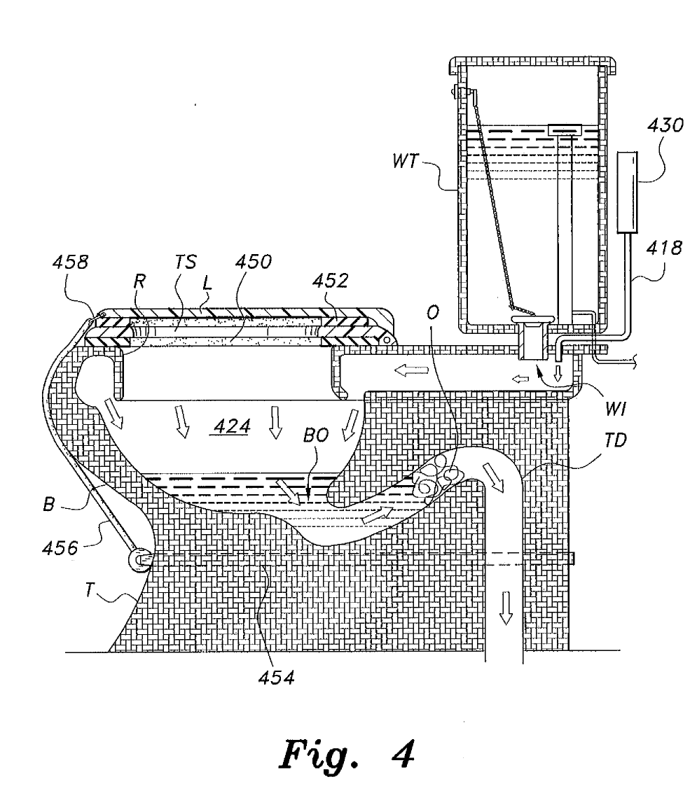

FIG. 4 of the drawings provides a side elevation view in section of a toilet T incorporating another embodiment of the pneumatic device for clearing drain obstructions. The toilet T of FIG. 4 is conventional, except for the components of the pneumatic device installed therein, the toilet T having a bowl B defining a bowl outlet BO and a rim R generally opposite the bowl outlet BO. A seat S and lid L are pivotally attached to the back of the rim R, the seat S and lid L selectively closing upon the rim R to define a chamber 424. A first pneumatic seal 450 is placed between the rim R of the bowl B and the overlying seat S. A second pneumatic seal 452 is placed between the seat S and the overlying lid L. These seals 450 and 452 may be permanently affixed to the undersides respectively of the seat S and lid L, or otherwise deployed when needed. The seals 450 and 452 form a pneumatically sealed bowl chamber 424 when the seat S and lid L are lowered, as shown in FIG. 4.

Positive security for the sealed chamber 424 is provided by a retainer selectively holding the lid L and the seat S closed over the rim R of the bowl B. The retainer may comprise a generally circumferential strap 454 surrounding the base of the toilet T, the strap 454 having an upward extension 456 extending from the front of the strap 454 to a latch arrangement 458 on the forward edge of the lid L. Tightening the strap 454 and the extension 456 pulls the lid L down tightly against the underlying seat S, and thus the seat S down tightly against the underlying rim R of the bowl B, thus compressing the two seals 450 and 452 to provide a good pneumatic seal for the bowl chamber 424.

In the embodiment of FIG. 4, an electropneumatic pump 430 is installed with the toilet T, e.g., at the back of the water tank WT or other convenient location. The electropneumatic pump 430 may be powered by one or more conventional electrical storage cells or batteries, or may be powered by a conventional remote electrical power source, e.g., electrical power grid, generator, etc., as in the case of the devices 110 of FIG. 1, 210 of FIGS. 2, and 310 of FIG. 3. The pump 430 may also include a conventional pressure regulator (not shown), as in the devices 110 of FIG. 1, 210 of FIGS. 2, and 310 of FIG. 3.

A pneumatic line or passage 418 extends from the pump 430 to a convenient location at the upper back of the bowl B, e.g., adjacent the water inlet WI from the water tank WT to the toilet T. When the seat S and lid L are pneumatically secured and sealed as shown in FIG. 4 and the electropneumatic pump 430 is actuated, air pressure is delivered from the pump 430 through the line or passage 418 and into the bowl B via the conventional water passages around the inside of the rim R of the bowl B. Pneumatic pressure builds within the pneumatically sealed bowl chamber 424 to force any obstruction O through the toilet drain or trap TD and on into the sewer system to clean out the obstruction O.

Accordingly, the several embodiments of the device serve to clear obstructions and clogs from the drains of sinks, toilets, and other plumbing fixtures. The devices are all closely related to one another by the use of electropneumatic pump and the creation of a pneumatically sealed chamber communicating with the drain in each embodiment. Any of the above-described embodiments may be applied to any compatible plumbing fixture for clearance of an obstruction therein.

It is to be understood that the present invention is not limited to the embodiments described above, but encompasses any and all embodiments within the scope of the following claims.

We claim:

1. A pneumatic device for clearing drain obstructions in a plumbing fixture, the plumbing fixture having a drain, the pneumatic device being adapted for defining a pneumatically sealed chamber with the drain of the plumbing fixture when applied thereto, the pneumatic device comprising:
an electropneumatic pump; and
a pneumatic line extending from the pump to the pneumatically sealed chamber.

2. The pneumatic device according to claim 1, further comprising:
a rigid, hollow shaft having a handle end and an outlet end opposite the handle end, the pneumatic line extending from the handle end to the outlet end of the shaft, the electropneumatic pump being disposed adjacent the handle end of the shaft; and
a resilient plunger force cup extending from the outlet end of the shaft, the plunger force cup being adapted for defining the pneumatically sealed chamber with the drain of the plumbing fixture when applied thereto, the plunger force cup having a pneumatic passage therethrough, the pump communicating pneumatically with the pneumatic line and with the plunger force cup, the pump selectively applying pneumatic pressure to the pneumatic tube and to the plunger force cup.

3. The pneumatic device according to claim 2, further comprising:
a distensible drain seal selectively extending from the plunger force cup; and
a piston disposed within the shaft, the piston being selectively displaced toward the outlet end of the shaft when the pump is actuated.

4. The pneumatic device according to claim 3, further comprising a semi-flexible wire extending from the piston and outwardly through the plunger force cup and the drain seal, the wire having a distal obstruction dislodging end, the wire being selectively driven outwardly from the drain seal by the piston when the pump is actuated.

5. The pneumatic device according to claim 1, further comprising:
a toilet having a bowl, the bowl having an outlet, a rim generally opposite the outlet, a seat selectively closed upon the rim, and a lid selectively closed upon the seat, the bowl, closed seat, and closed lid defining the pneumatically sealed chamber;
a first pneumatic seal disposed between the rim of the bowl and the seat; and
a second pneumatic seal disposed between the seat and the lid.

6. The pneumatic device according to claim 5, further comprising a retainer selectively holding the lid and the seat closed over the rim of the bowl.

7. The pneumatic device according to claim 1, further comprising a pressure regulator selectively controlling the pump.

8. A pneumatic device for clearing drain obstructions in a plumbing fixture, the plumbing fixture having a drain, the pneumatic device comprising:
a rigid, hollow shaft having a handle end, an outlet end opposite the handle end, and a pneumatic passage extending from the handle end to the outlet end;
a resilient plunger force cup extending from the outlet end of the shaft, the plunger force cup being adapted for defining a pneumatically sealed chamber with the drain of the plumbing fixture when applied thereto, the plunger force cup having a pneumatic passage therethrough;
an elongate pneumatic tube extending from the handle end of the shaft to the plunger force cup; and
an electropneumatic pump disposed adjacent the handle end of the shaft, the pump communicating pneumatically with the pneumatic tube, the plunger force cup, and the pneumatic passage of the shaft, the pump selectively applying pneumatic pressure to the pneumatic tube, the plunger force cup, and the pneumatic passage of the shaft.

9. The pneumatic device according to claim 8, further comprising:
a distensible drain seal selectively extending from the plunger force cup; and
a piston disposed within the shaft, the piston being selectively displaced toward the outlet end of the shaft when the pump is actuated.

10. The pneumatic device according to claim 9, further comprising a semi-flexible wire extending from the piston and outwardly through the plunger force cup and the drain seal, the wire having a distal obstruction dislodging end, the wire being selectively driven outwardly from the drain seal by the piston when the pump is actuated.

11. The pneumatic device according to claim 8, further comprising a pressure regulator selectively controlling the pump.

12. A pneumatic device for clearing drain obstructions in a plumbing fixture, the plumbing fixture comprising a toilet having a bowl, the bowl having an outlet, a rim generally opposite the outlet, a seat selectively closed upon the rim, and a lid selectively closed upon the seat, the pneumatic device comprising:
an electropneumatic pump;
a pneumatic tube extending from the pump to the bowl, the pump selectively delivering pneumatic pressure to the bowl through the pneumatic tube;
a first pneumatic seal disposed between the rim of the bowl and the seat; and
a second pneumatic seal disposed between the seat and the lid.

13. The pneumatic device for clearing drain obstructions in a plumbing fixture according to claim 12, further comprising a retainer selectively holding the lid and the seat closed over the rim of the bowl.

14. The pneumatic device according to claim 12, further comprising a pressure regulator selectively controlling the pump.
